(19) United States
(12) Patent Application Publication
(10) Pub. No.: US 2008/0056802 A1
(43) Pub. Date: Mar. 6, 2008

(54) Artist's painting brush and method for using same

(76) Inventor: Sossy Baghdoian, Toluca Lake, CA (US)

Correspondence Address: SANDRA LEE LIPKIN;A LAW CORPORATION, 1891 GOODYEAR AVE., SUITE 622, VENTURA, CA, 93003, US

(21) Appl. No.: 11/708,991

(22) Filed: Feb. 20, 2007

Related U.S. Application Data
(60) Provisional application No. 60/793,327, filed on Aug. 31, 2006.

(51) Int. Cl. A46B 11/00; B43K 27/08

(52) U.S. Cl. 401/45; 401/34; 401/35

(57) ABSTRACT

An artist's painting brush and method for using same wherein one or more chambers are located in the handle of the brush for the containment of one or more colors of paint having fluid viscosity. The handle is hollow and has a cap on one end for the addition of paint and securing of same therein. Inside the hollow handle is a barrier that separates the paint from the second end of the handle. The second end of the handle contains an absorbent means that absorbs the paint prior to application. On the outside of the handle are activation means to correspond to each reservoir that allows the barrier between the reservoir and the sponge to be breached. The sponge then absorbs the paint and pre-mixes any combination thereof. Upon depression of the second end of the handle wherein there exists a plurality of bristles for the application of the paint, the pre-mixed color or single color paint absorbed in the absorbent means is transferred to the canvas or other artist's media. Barriers exist among the plurality of filaments to correspond to the number of chambers in the hollow handle of the brush

### REFERENCE TO PRIOR APPLICATION

This application claims the priority of provisional application 60/793,327, filed Aug. 31, 2006 entitled ARTIST'S PAINTING BRUSH by Sossy Baghdoian.

### BACKGROUND OF THE INVENTION

1. Field of the Invention

The present invention relates generally to the field of artist paint brushes and more specifically to an artist's painting brush that can house one or more colors at a time, thereby eliminating the need for color mixing on a palette.

2. Description of the Prior Art

Artist's painting brushes are well-known in the art. Typically, a paint brush has a handle made of a sturdy material that has a series of bristles, either natural or synthetic, at the end of the handle for dipping in paint and ultimately applying to a canvas or other artistic media. Often, an unmodified color does not provide the proper hue as envisioned by the artist. In this case, the brush is usually dipped in more than one color to provide a blend that is the color desired by the artist. In the case of water colors, the brush is dipped in water prior to being dipped in the color to provide fluid viscosity. Typically, the colors are mixed on a canvas for a uniform color. The artist dips the brush in one color and applies it to a palette or the paint is applied directly the palette. Subsequent colors are added either directly to the palette or with a brush and then mixed on the palette before the color mixture is applied to the canvas or other media.

Often times, an artist may find it advantageous to avoid the step of mixing the colors on a palette, particularly when working with painting media such as water colors or acrylics that have a fluid viscosity. It is desirable that a combination of two or more colors be available to the artist already in the handle portion of the brush for application directly to the canvas or other media. When more than one color is desired, it would be advantageous if the artist had the option of pre-mixing the colors in the brush prior to application on the canvas or other media and without the necessity of the intermediate step of mixing the colors on a palette.

Prior art has addressed this need in some ways, but in ways that are not as simple and easy to use as the current invention. Furthermore, prior art does not provide reservoirs for more than one fluid color to be mixed. Accordingly, there exists a need for an artist's painting brush that has reservoirs for one or more colors of paint having fluid viscosity that can be manipulated easily and readily through the handle by the artist in order to apply one or more combination of colors to the canvas or other media.

### SUMMARY OF THE INVENTION

The preferred embodiment of the present invention teaches an artist's painting brush, comprising a handle with a hollow interior having a first end and a second end; an opening on the first end of the handle; an absorbent means located inside the hollow interior of the handle at the second end of the handle; barrier means to separate the hollow interior from the absorbent means; activation means to remove the barrier means between the hollow interior and the absorbent means; a plurality of bristles attached to the second end of the handle and extending therefrom.

The embodiment above is further modified by defining that the hollow interior is divided into two or more chambers.

The embodiment above is further modified by defining that the plurality of bristles are separated by one or more barriers to correspond to the two or more chambers in the hollow interior.

The embodiment above is further modified by defining that the absorbent means is a sponge or any other absorbent means.

The embodiment above is further modified by defining that the barrier means further comprises a wall that extends from the activation means and the second end of the handle.

The embodiment above is further modified by defining that the activation means further comprises one or more depressable buttons on the outer surface of the handle wherein there is one depressable button for each chamber containing a color variety.

The embodiment above is further modified by defining that there is a capping means on the first end of the handle allowing for the filling of paint and securing same therein.

The second embodiment of the present invention is a method of applying paint of fluid viscosity to a canvas or other media comprising filling one or more chambers of an artist's painting brush with paint having fluid viscosity, the painting brush further comprising a handle with a hollow interior having a first end and a second end; an opening on the first end of the handle; an absorbent means located inside the hollow interior of the handle at the second end of the handle; barrier means to separate the hollow interior from the absorbent means; activation means to remove the barrier means between the hollow interior and the absorbent means; a plurality of bristles attached to the second end of the handle and extending therefrom; activating the activation means to remove the barrier means between the hollow interior and the absorbent means to allow the paint to be absorbed by the absorbent means; applying the plurality of bristles to a canvas or other artist media by applying pressure on the second end of the handle and releasing the paint from the absorbent means.

The embodiment above is further modified by defining that the hollow interior is divided into two or more chambers.

The embodiment above is further modified by defining that the plurality of bristles are separated by one or more barriers to correspond to the two or more chambers in the hollow interior.

The embodiment above is further modified by defining that the absorbent means is a sponge.

The embodiment above is further modified by defining that the barrier means further comprises a wall that extends from the activation means and the second end of the handle.

The embodiment above is further modified by defining that the activation means further comprises a depressable button on the outer surface of the handle.

The embodiment above is further modified by defining that there is a capping means on the first end of the handle allowing for the filling of paint and securing same therein.

### BRIEF DESCRIPTION OF THE DRAWINGS

FIG. 1 is a side view of the invention with one chamber for paint.

FIG. 2 is a side view of the invention with two chambers for paint.

FIG. 3 is a side view of the device with one of the chambers activated by the artist's thumb.

FIG. 4 is taken along line 4-4 in FIG. 3

FIG. 5 is a variation of FIG. 4 wherein eight chambers exist for paint.

### DETAILED DESCRIPTION OF A PREFERRED EMBODIMENT

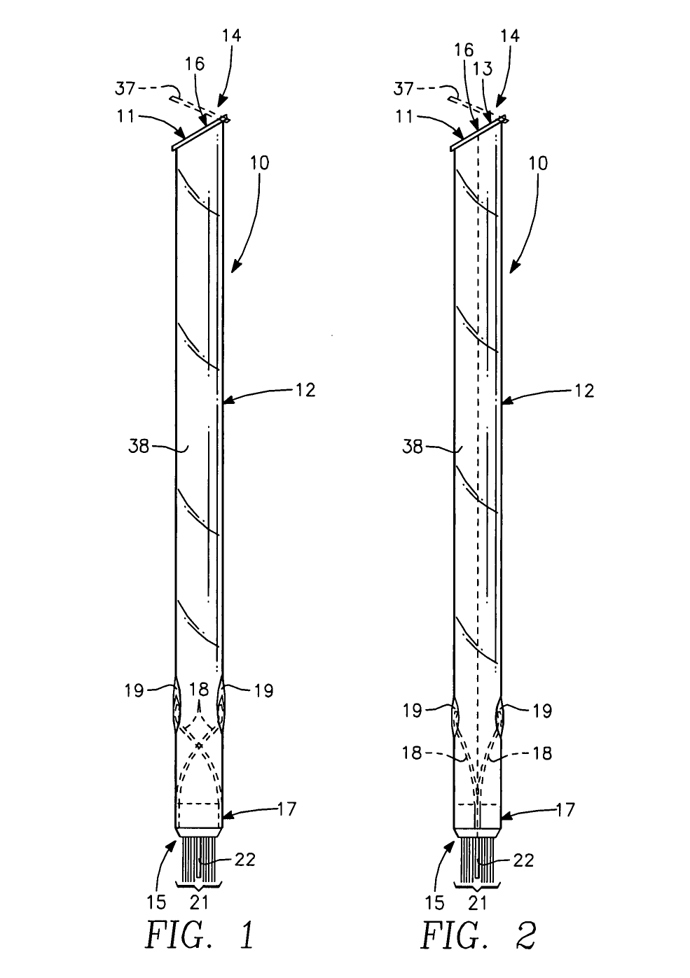

Turning to the drawings, FIG. 1 shows the simplest embodiment of the artist's painting brush 10 of the current invention. The artist's painting brush 10 in its simplest form has a single chamber 11 inside of the handle 12. The handle 12 has a hollow interior 38 and a first end 14 and a second end 15. On the first end 14 is an opening 16. On the second end 15 and in the interior hollow portion 38 of the handle 12 is an absorbent means 17.

Inside the hollow portion 38 of the handle 12 is a barrier means 18 that separates the hollow interior 38 of the handle 11 from the absorbent means 17. On the outside of the handle 12 is an activation means 19 that when activated, typically by the thumb 20 of the artist, the barrier means 18 between the hollow interior 38 of the handle 12 and the absorbent means 17 is breached, thereby allowing the flow of paint housed in the hollow portion 38 of the handle 12 into the absorbent means 17, which would typically be a sponge.

At the second end 15 of the handle 12 is a plurality of bristles 21 for the application of the paint absorbed in the sponge 17 when applied to a canvas or other artist's media (not shown).

As seen in FIG. 2, the hollow interior portion of the handle 12 of the brush 10 can be divided into two or more chambers 11, 13. FIG. 4 shows a top view of the handle 12 when there are barriers 25, 26 provided that create four chambers 11, 13, 23, 24. Similarly, FIG. 5 shows a top view of the handle 12 when there are four barriers 25, 26, 27, 28 that allow for the creation of eight chambers 29, 30, 31, 32, 33, 34, 35, 36.

Optionally, the plurality of bristles 21 can be separated by one or more barriers 22 that correspond to the two or more chambers 11, 13 created in the hollow interior 38 of the handle 12 by the corresponding number of barriers inside the hollow portion 38.

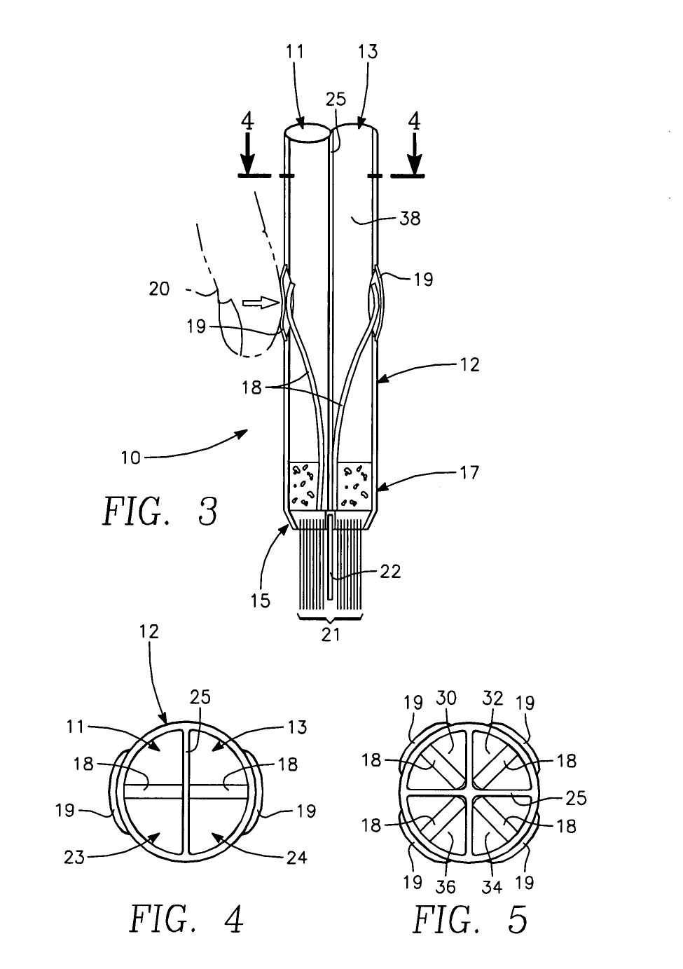

As seen most clearly in FIG. 3, the barrier means 18 separating the hollow portion 38 of the interior of the handle 12 from the sponge 17 is a wall that extends from the activation means 19 on the exterior of the handle 12 down toward the second end 15 of the handle 12. When the artist depresses the activation means 19, which is typically a depressable button, with his or her thumb 20, the barrier 18 is breached and paint held in the hollow interior portion 38 is absorbed into the sponge 17. When more than one chamber is present and each chamber holds a different color, the sponge 17 absorbs each color and pre-mixes before application of the bristles 21 to a canvas or other artist's media.

On the first end 14 of the handle 12 is a capping means 37 that allows for entrance into the hollow portion 38 of the handle 12 for a paint of fluid viscosity, such as water color or acrylic media. Once the chambers are filled with the paint, the capping means 37 is then closed to secure the paint therein.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

What is claimed is:

1. An artist's painting brush, comprising
a handle with a hollow interior having a first end and a second end;
an opening on said first end of said handle;
an absorbent means located inside said hollow interior of said handle at said second end of said handle;
barrier means to separate said hollow interior from said absorbent means;
activation means to remove said barrier means between said hollow interior and said absorbent means;
a plurality of bristles attached to said second end of said handle and extending therefrom.

2. An artist's painting brush as defined in claim 1 wherein said hollow interior is divided into two or more chambers.

3. An artist's painting brush as defined in claim 2 wherein said plurality of bristles are separated by one or more barriers to correspond to said two or more chambers in said hollow interior.

4. An artist's painting brush as defined in claim 1 wherein said absorbent means is a sponge.

5. An artist's painting brush as defined in claim 1 wherein said barrier means further comprises a wall that extends from said activation means and said second end of said handle.

6. An artist's painting brush as defined in claim 1 wherein said activation means further comprises a depressable button on the outer surface of said handle.

7. An artist's painting brush as defined in claim 1 wherein there is a capping means on said first end of said handle allowing for the filling of paint and securing same therein.

8. A method of applying paint of fluid viscosity to a canvas or other media comprising
filling one or more chambers of an artist's painting brush with said
paint having fluid viscosity, said painting brush further comprising
a handle with a hollow interior having a first end and a second end;
an opening on said first end of said handle;
an absorbent means located inside said hollow interior of said handle at said second end of said handle;
barrier means to separate said hollow interior from said absorbent means;
activation means to remove said barrier means between said hollow interior and said absorbent means;
a plurality of bristles attached to said second end of said handle and extending therefrom;
activating said activation means to remove said barrier means between said hollow interior and said absorbent means to allow said paint to be absorbed by said absorbent means;
applying said plurality of bristles to a canvas or other artist media by applying pressure on said second end of said handle and releasing said paint from said absorbent means.

9. A method as defined in claim 8 wherein said hollow interior is divided into two or more chambers.

10. A method as defined in claim 9 wherein said plurality of bristles are separated by one or more barriers to correspond to said two or more chambers in said hollow interior.

11. A method as defined in claim 8 wherein said absorbent means is a sponge.

12. A method as defined in claim 8 wherein said barrier means further comprises a wall that extends from said activation means and said second end of said handle.

13. A method as defined in claim 8 wherein said activation means further comprises a depressable button on the outer surface of said handle.

14. A method as defined in claim 8 wherein there is a capping means on said first end of said handle allowing for the filling of paint and securing same therein.
